(19) United States
(12) Patent Application Publication
(10) Pub. No.: US 2024/0234745 A9
(43) Pub. Date: Jul. 11, 2024

(54) METHOD AND SYSTEM FOR MANUFACTURING MEMBRANE-ELECTRODE-GAS DIFFUSION LAYER ASSEMBLY FOR FUEL CELL

(71) Applicants: Kia Corporation, Seoul (KR); Hyundai Motor Company, Seoul (KR)

(72) Inventors: Han Hyung Lee, Goyang-si (KR); Yong Seok Lee, Seoul (KR); Sun II Kim, Seoul (KR); Seung Ah Yu, Yongin-si (KR)

(21) Appl. No.: 18/345,776

(22) Filed: Jun. 30, 2023

(30) Foreign Application Priority Data
Oct. 25, 2022 (KR) 10-2022-0137915

(51) Int. Cl. H01M 4/88; H01M 4/86; H01M 8/1004

(52) U.S. Cl. CPC H01M 4/8807; H01M 4/8605; H01M 8/1004

(57) ABSTRACT

In an embodiment a method includes manufacturing a membrane-electrode-gas diffusion layer assembly (MEGA) fabric by bonding a gas diffusion layer (GDL) material to a first surface of a membrane-electrode assembly (MEA) fabric, injecting, by a steam injector, a liquid material to a first surface of the MEGA fabric while allowing the liquid material to be absorbed to the first surface of the MEGA fabric, supplying, by a gas injector, compressed gas to a second surface of the MEGA fabric in which the liquid material has been absorbed, inspecting, by a surface inspection device, a surface state of the MEGA fabric after supplying the compressed gas and, after inspecting, winding the MEGA fabric around a MEGA winding unit.

### CROSS-REFERENCE TO RELATED APPLICATIONS

This application claims priority to Korean Patent Application No. 10-2022-0137915 filed on Oct. 25, 2022, the entire content of which is incorporated herein by reference.

### TECHNICAL FIELD

The present disclosure relates to a method and system for manufacturing a membrane-electrode-gas diffusion layer assembly (MEGA) for a fuel cell, and more particularly, to a method and system for manufacturing a MEGA for a fuel cell, which are capable of checking the bonding state between a membrane-electrode assembly (MEA) and a gas diffusion layer (GDL) during the manufacturing process of the MEGA.

### BACKGROUND

A polymer electrolyte membrane fuel cell (PEMFC) is a high-output fuel cell with high current density, which has a simple structure, and exhibits excellent startability and responsiveness.

FIG. 1 shows a typical polymer electrolyte fuel cell, and FIG. 2 shows a typical membrane-electrode-gas diffusion layer assembly for a fuel cell.

As shown in FIG. 1, in general, the unit cell of the PEMFC includes a membrane-electrode assembly (MEA) 1, a pair of gas diffusion layers (GDLs) 2,2′ bonded to both surfaces of the MEA 1, a gasket 3 fixed to any one of the GDLs 2, 2′, and a pair of separators 4 and 4′ stacked on the outermost side.

The process of manufacturing the unit cell includes a process of manufacturing a membrane-electrode-gas diffusion layer assembly (MEGA) by bonding the GDL to the MEA. As shown in FIG. 2, the MEGA 100′ includes an MEA 110′ and a GDL 120′ bonded to one surface of the MEA 110′.

The method of bonding the GDL to the first surface of the MEA includes a method in which MEA wound on the first roller and GDL wound on the second roller are unwound, respectively, and laminated while being passed through a bonding roller with a heating function, and a method in which MEA and GDL cut to a predetermined size in a sheet unit are laminated using a flat press.

In addition, when manufacturing the unit cell, the second GDL is bonded to the second surface of the MEA immediately after manufacturing the MEGA, or the second GDL is bonded to the second surface of the MEA after the gasket is bonded on the first GDL bonded to the first surface of the MEA.

However, the GDL has a rough surface roughness and a thickness variation because it is made of a material in which carbon-fiber is entangled. Therefore, even under normal bonding conditions, the MEA and the GDL may not be properly bonded to each other due to the surface roughness or the thickness deviation.

Accordingly, it is necessary to check the bonding state between the MEA and the GDL during the manufacture of the MEGA. However, after bonding the second GDL to the second surface of the MEA, both surfaces of the MEA are covered by the GDLs, and thus, it is impossible to check the bonding state between the first GDL and the MEA through the surface state of the MEA.

Accordingly, in order to detect a bonding defect between the MEA and the GDL during the manufacturing of the MEGA, it is necessary to check the bonding state between the first GDL and the MEA right after bonding the first GDL to the first surface of the MEA.

### SUMMARY

Embodiments provide a method and system for manufacturing a MEGA for a fuel cell, which are capable of checking the bonding state of a MEA and a GDL during the manufacturing process of the MEGA, detecting a bonding defect between the MEA and the GDL, and thus reducing the product defect rate.

Embodiments provide a method for manufacturing a MEGA for a fuel cell, wherein the method includes: manufacturing a membrane-electrode-gas diffusion layer assembly (MEGA) fabric by bonding a gas diffusion layer (GDL) material to a first surface of a membrane-electrode assembly (MEA) fabric; injecting a liquid material through a steam injection device to a first surface of the MEGA fabric while allowing the liquid material to be absorbed to the first surface of the MEGA fabric; injecting and supplying compressed gas through a gas injection device to a second surface of the MEGA fabric in which the liquid material has been absorbed; inspecting, through a surface inspection device, a surface state of the MEGA fabric which has been supplied with the compressed gas; and winding the MEGA fabric, which has been inspected through the surface inspection device, around a MEGA winding unit.

According to an embodiment of the present disclosure, the first surface of the MEGA fabric is a second surface of the MEA fabric, to which the GDL material is not bonded.

Additionally, the second surface of the MEGA fabric is a surface of the GDL material bonded to the first surface of the MEA fabric.

Additionally, the GDL material has a porous structure.

Additionally, the MEA fabric includes an electrolyte membrane fabric that expands when absorbing the liquid material, and a plurality of electrodes provided on both surfaces of the electrolyte membrane fabric.

Additionally, the gas injection device includes: a gas injection unit which is positioned below the second surface of the MEGA fabric, and injects the compressed gas toward the second surface of the MEGA fabric; and a jig unit which is positioned above the first surface of the MEGA fabric so as to be movable up and down, and is moved to bring the second surface of the MEGA fabric into close contact with the gas injection unit.

Additionally, the gas injection unit is configured to inject the compressed air when the second surface of the MEGA fabric is brought into close contact with the gas injection unit by the jig unit.

Additionally, the jig unit has a frame structure having an inner diameter greater than an outer diameter of the electrode provided on the MEA fabric.

Additionally, when the jig unit is moved toward the first surface of the MEGA fabric, the jig unit is moved so that the electrode of the MEA fabric is positioned in an inner space of the jig unit.

Additionally, the method for manufacturing a MEGA for a fuel cell further includes forming a marking on a region of the MEGA fabric where a surface abnormality is detected when the surface abnormality of the MEGA fabric is detected through the surface inspection device.

Further embodiments provide a system for manufacturing a MEGA for a fuel cell, wherein the system includes: a fabric bonding device for manufacturing a membrane-electrode-gas diffusion layer assembly (MEGA) fabric by bonding a gas diffusion layer (GDL) material to a first surface of a membrane-electrode assembly (MEA) fabric; a steam injection device for injecting a liquid material on a first surface of the MEGA fabric; a gas injection device for injecting a compressed gas to a second surface of the MEGA fabric to which the liquid material has been absorbed; a surface inspection device for inspecting a surface state of the MEGA fabric to which the compressed gas has been injected; and a MEGA winding unit for winding the MEGA fabric which has been inspected through the surface inspection device.

According to the above-described means for solving the problems, the present disclosure can inspect the non-bonding region between the MEA and GDL or the insufficient bonding strength region during the manufacturing process of the MEGA, and detect the bonding abnormality between the MEA and the GDL, thereby reducing the defect rate of the MEGA. Additionally, the present disclosure can also reduce the product defect rate of the fuel cell manufactured by using the MEGA.

The effects of the present disclosure are limited to the above-described effects, and unmentioned other effects of the present disclosure may be appreciated clearly from the following detailed description by a person having ordinary skill in the art to which the present disclosure belongs.

### BRIEF DESCRIPTION OF THE DRAWINGS

The above and other features of the present disclosure will now be described in detail with reference to certain exemplary examples thereof illustrated in the accompanying drawings which are given herein below by way of illustration only, and thus are not limitative of the present disclosure, and wherein:

FIG. 1 is a diagram showing a typical polymer electrolyte fuel cell;

FIG. 2 shows a typical membrane-electrode-gas diffusion layer assembly (MEGA) for a fuel cell;

FIG. 3 is a configuration diagram showing a system for manufacturing a MEGA for a fuel cell according to an embodiment of the present disclosure;

FIG. 4A is a diagram showing a gas injection device according to an embodiment of the present disclosure;

FIG. 4B is a diagram showing an operating state of a gas injection device according to an embodiment of the present disclosure;

FIG. 5 is a diagram of the operating state of a gas injection device according to an embodiment of the present disclosure when viewed from the above of a MEGA fabric;

FIG. 6 is a configuration diagram showing a system for manufacturing a MEGA for a fuel cell according to another embodiment of the present disclosure; and

FIG. 7 is a diagram showing, as an example, a defect detection procedure of a MEGA fabric during a manufacturing process using a system for manufacturing a MEGA for a fuel cell according to an embodiment of the present disclosure.

It should be understood that the appended drawings are not necessarily to scale, presenting a somewhat simplified representation of various preferred features illustrative of the basic principles of the disclosure. The specific design features of the present disclosure as disclosed herein, including, for example, specific dimensions, orientations, locations, and shapes will be determined in section by the particular intended application and use environment.

In the figures, reference numbers refer to the same or equivalent sections of the present disclosure throughout the several figures of the drawing.

### DETAILED DESCRIPTION OF ILLUSTRATIVE EMBODIMENTS

Specific structural or functional descriptions presented in the embodiments of the present disclosure are provided merely by way of example for the purpose of describing embodiments according to the concept of the present disclosure, and the embodiments according to the concept of the present disclosure may be realized in various forms.

Also, throughout this specification, when a part “comprises” or “includes” a component, it means not that the part excludes other component, but instead that the part may further include other component unless expressly stated to the contrary.

Meanwhile, terms such as first, second and the like may be used to explain various components, but the components are not limited to these terms. Said terms are used in order only to distinguish one component from another component. For example, the first component can be designated as the second component without departing from the right scope of the present disclosure concepts, and, similarly, the second component can also be designated as the first component.

Hereinafter, embodiments of the present disclosure will be described with reference to the accompanying drawings. Matters in the accompanying drawings are shown schematically for easy explanation of the embodiments of the present disclosure, and may be different from the forms that would be actually implemented.

The present disclosure relates to a method for manufacturing a membrane-electrode-gas diffusion layer assembly (MEGA) for a fuel cell including a process for checking the bonding state of the MEGA, by which the bonding state of a membrane-electrode assembly (MEA) and a gas diffusion layer (GDL) can be checked during the manufacturing process of the MEGA, so that the defective bonding between the MEA and the GDL can be detected before completing the manufacturing of MEGA, thereby reducing the product defect rate.

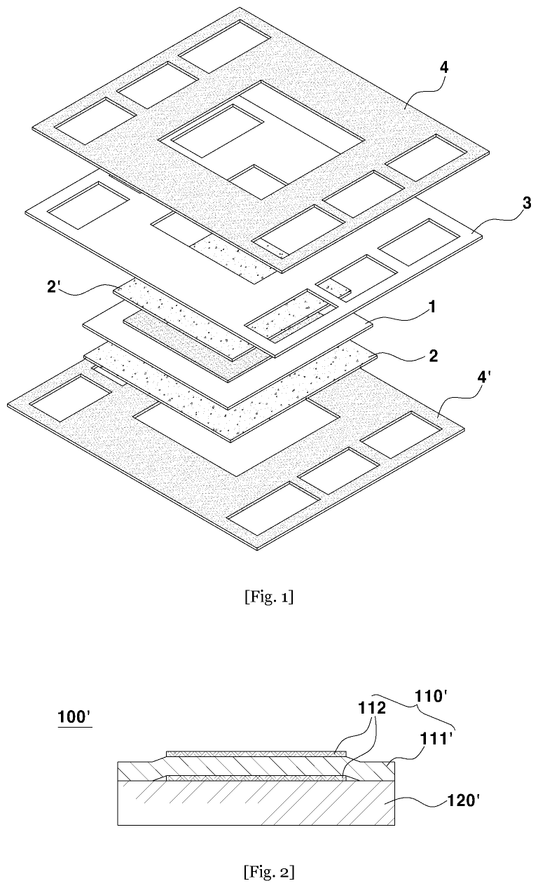

Before describing the method for manufacturing a MEGA of the present disclosure, the structure of the MEGA for a fuel cell will be briefly described with reference to FIG. 2.

FIG. 2 illustrates, as an example, a cross-sectional structure of a MEGA constituting a unit cell of a general polymer electrolyte membrane fuel cell (PEMFC). As shown in FIG. 2, the MEGA 100′ includes an MEA 110′ and a GDL 120′ bonded to one surface of the MEA 110′, and the MEA 110′ includes an electrolyte membrane 111′ having liquid absorption property, and a pair of electrodes 112 bonded to both surfaces of the electrolyte membrane. The unit cell of the PEMFC may be manufactured by employing the MEGA 100′.

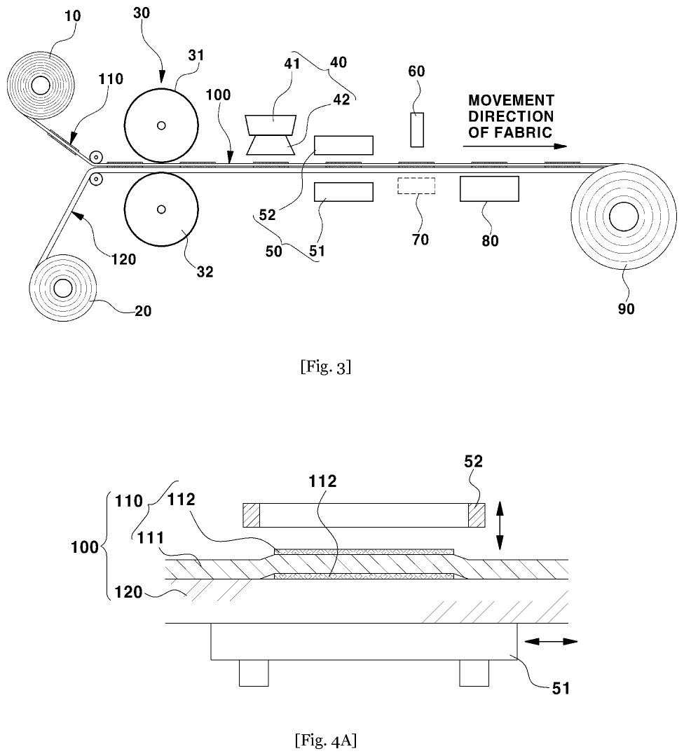

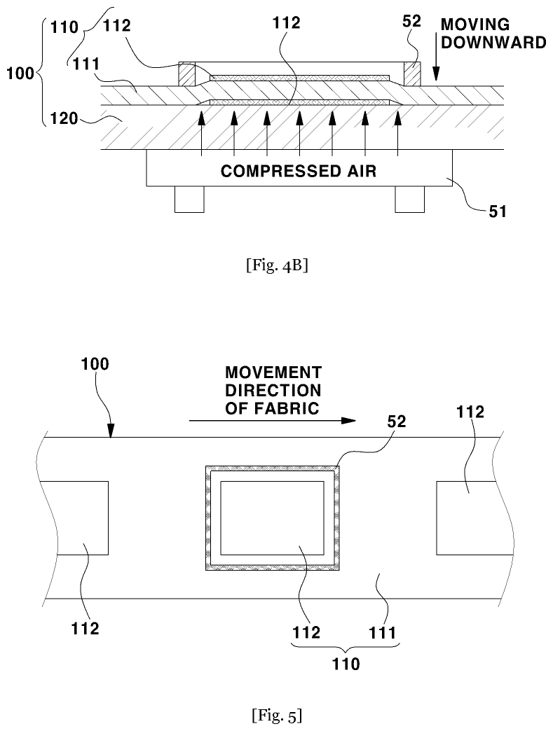

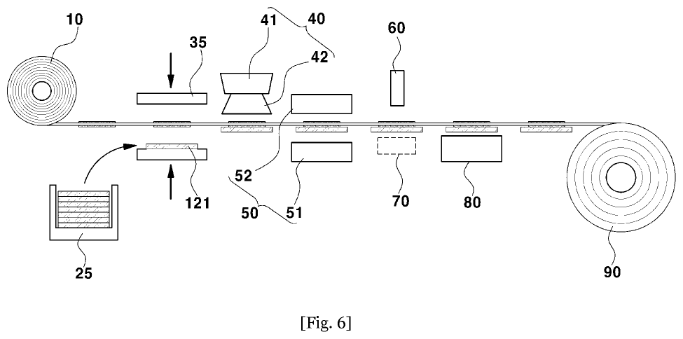

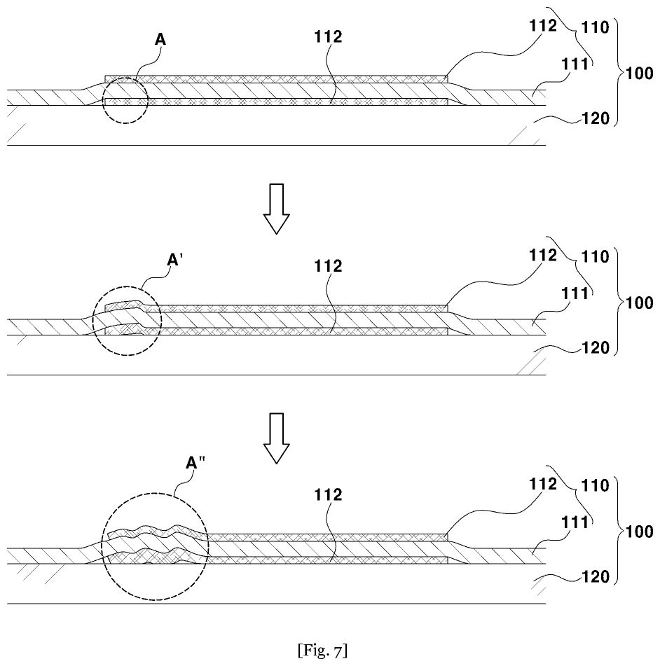

Accompanying FIG. 3 is a configuration diagram showing a system for manufacturing a MEGA for a fuel cell according to an embodiment of the present disclosure, FIG. 4A is a diagram showing a gas injection device of the system for manufacturing a MEGA, FIG. 4B is a diagram showing an operating state of the gas injection device, FIG. 5 is a diagram of the operating state of the gas injection device when viewed from the above of the MEGA fabric. Also, FIG. 6 is a configuration diagram showing a system for manufacturing a MEGA for a fuel cell according to another embodiment of the present disclosure, and FIG. 7 is a diagram showing, as an example, a defect detection procedure of a MEGA fabric during a manufacturing process using a system for manufacturing a MEGA for a fuel cell according to an embodiment of the present disclosure.

The method for manufacturing a MEGA of the present disclosure may be performed through the system shown in FIG. 3. As shown in FIG. 3, the system for manufacturing a MEGA of the present disclosure includes an MEA unwinding unit 10, a GDL unwinding unit 20, a bonding roller 30, a steam injection device 40, a gas injection device 50, a surface inspection device 60, a drying device 80, and a MEGA winding unit 90. Additionally, although not shown in the drawings, the system for manufacturing a MEGA includes a controller for performing overall control of the system, and is driven by the controller.

The MEA unwinding unit 10 with the MEA fabric 110 wound therearound is driven to unwind the MEA fabric 110 when being supplied with power. At this time, the unwound MEA fabric 110 is moved toward the bonding roller 30.

Referring to FIG. 4A, the MEA fabric 110 includes an electrolyte membrane fabric 111 having a property of expanding when absorbing a liquid material, and a plurality of electrodes 112 provided on both surfaces of the electrolyte membrane fabric 111. The electrodes 112 are positioned spaced apart from each other in the longitudinal direction of the electrolyte membrane fabric 111 on both surfaces of the electrolyte membrane fabric 111.

The GDL unwinding unit 20 with the GDL fabric 120 wound therearound is driven to unwind the GDL fabric 120 when being supplied with power. At this time, the unwound GDL fabric 120 is moved toward the bonding roller 30. The MEA unwinding unit 10 and the GDL unwinding unit 20 continuously unwind the MEA fabric 110 and the GDL fabric 120 while power is supplied.

The bonding roller 30 includes a first roller 31 and a second roller 32. The MEA fabric 110 and the GDL fabric 120 are passed between the first roller 31 and the second roller 32, and are moved toward the steam injection device 40. At this time, the MEA fabric 110 and the GDL fabric 120 are heated and pressed by the first roller 31 and the second roller 32 to be bonded to each other. Also at this time, the GDL fabric 120 is bonded to the first surface of the MEA fabric 110.

The bonding roller 30 manufactures the MEGA fabric 100 by bonding the MEA fabric 110 unwound from the MEA unwinding unit 10 and the GDL fabric 120 unwound from the GDL unwinding unit 20. The MEGA fabric 100 includes the MEA fabric 110 and the GDL fabric 120 bonded to the first surface of the MEA fabric 110.

Referring to FIGS. 3 and 4A, the MEGA fabric 100 includes the MEA fabric 110 having a predetermined length and the GDL fabric 120 bonded to one surface of the MEA fabric 110.

The steam injection device 40 is positioned between the bonding roller 30 and the gas injection device 50, and is configured to inject steam to the first surface of the MEGA fabric 100 moving from the bonding roller 30 to the gas injection device 50 side. The first surface of the MEGA fabric 100 is the second surface of the MEA fabric 110, to which the GDL fabric 120 is not bonded. The second surface of the MEGA fabric 100 is the surface of the GDL fabric 120, which faces opposite to the MEA fabric 110. That is, the second surface of the MEGA fabric 100 is the outer surface of the GDL fabric 120 bonded to the first surface of the MEA fabric 110.

As shown in FIG. 3, the steam injection device 40 includes a water storage tank 41 in which a liquid material injected on the second surface of the MEA fabric 110 (i.e., the first surface of the MEGA fabric) is stored, and a nozzle 42 for injecting the liquid material vaporized in the water storage tank 41 to the first surface of the MEGA fabric 100.

The nozzle 42 injects a vaporized liquid material (i.e., steam) on the first surface of the MEGA fabric 100 moving toward the gas injection device 50. At this time, the nozzle 42 is positioned above the MEGA fabric 100 so as to face the first surface of the MEGA fabric 100, and injects the steam downward in the vertical direction to the first surface of the MEGA fabric 100.

The liquid material stored in the water storage tank 41 is vaporized in the water storage tank 41 by a vaporization means. For example, the material stored in the water storage tank 41 may be vaporized by a heating vaporization means using heat, ultrasonic vaporization means using ultrasonic vibration, or the like.

Specifically, water is used as the material injected to the MEGA fabric 100, but alcohol-based materials that affect the properties of the electrode 112 or the electrolyte membrane 111′ of the MEA fabric 110 cannot be used.

The gas injection device 50 is a device configured to inject a compressed gas of a predetermined pressure to the MEGA fabric 100. As shown in FIG. 4A, the gas injection device 50 includes a gas injection unit 51 and a jig unit 52.

The gas injection unit 51 is configured to inject and supply the compressed gas to the MEGA fabric 100. The gas injection unit 51 is positioned below the second surface of the MEGA fabric 100 to face the second surface of the MEGA fabric 100 and injects the compressed gas in a vertical direction to the second surface of the MEGA fabric 100. A plurality of fine holes through which compressed gas is injected may be provided in the upper surface of the gas injection unit 51.

The jig unit 52 is positioned above the first surface of the MEGA fabric 100 to face the first surface of the MEGA fabric 100, and is configured to be movable up and down through a separate driving unit. As shown in FIG. 4B, the jig unit 52 may be moved downward toward the MEGA fabric 100 to bring the second surface of the MEGA fabric 100 into close contact with the upper surface of the gas injection unit 51, and may be moved upward from the MEGA fabric 100 to return to its original position. For example, the jig unit 52 is moved upward when the gas injection of the gas injection unit 51 is stopped or completed.

The jig unit 52 is formed in a rectangular pipe structure with an open upper side and an open lower side. In other words, as shown in FIG. 5, the jig unit 52 is formed in a rectangular frame structure having an inner diameter greater than the outer diameter of the electrode 112. The jig unit 52 surrounds the periphery of the electrode 112 with a predetermined gap therebetween when bringing the MEGA fabric 100 into close contact with the upper surface of the gas injection unit 51. In other words, when the jig unit 52 is moved downward toward the first surface of the MEGA fabric 100, the electrode 112 of the MEA fabric 110 is positioned in the inner space of the jig unit 52.

Accordingly, the jig unit 52 can bring the second surface of the MEGA fabric 100 into close contact with the gas injection unit 51 without being in contact with the electrode 112, and can allow the compressed gas injected from the gas injection unit 51 to be concentrated on a predetermined region of the MEGA fabric 100 where the electrode 112 is located.

Air is used as the gas injected from the gas injection unit 51, and an inert gas or nitrogen gas that does not affect the characteristics of the fuel cell may also be used.

When the second surface of the MEGA fabric 100 is in close contact with the upper surface of the gas injection unit 51 by the jig unit 52, the gas injection unit 51 injects compressed air.

On the other hand, when the MEGA is manufactured by a continuous process method in which the MEGA fabric 100 is continuously moved, it is necessary to move the gas injection unit 51 together with the MEGA fabric 100. Accordingly, the gas injection device 50 may further include a linear driving device for reciprocating the gas injection unit 51 in the horizontal direction. As the linear driving device, a known device may be used.

Although not shown in the drawings, the linear driving device may include a linear rail for guiding the horizontal movement of the gas injection unit 51, and a driving unit for horizontally moving the gas injection unit 51 along the linear rail at the same speed as the MEGA fabric 100. At this time, the linear rail is elongate along the movement direction of the MEGA fabric 100, and the driving unit moves the gas injection unit 51 assembled to the linear rail in the same direction as the MEGA fabric 100. Additionally, when the electrode 112 of the MEGA fabric 100 is positioned on the gas injection unit 51, the driving unit may move the gas injection unit 51 at the same speed as the MEGA fabric 100 and the electrode 112. The driving unit may also return the gas injection unit 51 to its original position when the gas injection of the gas injection unit 51 is completed. In addition, although not shown in the drawings, when the gas injection device 50 further includes the linear driving device for the gas injection unit 51, it further includes a linear driving device for the jig unit 52.

Referring to FIG. 3, the surface inspection device 60 is positioned above the first surface of the MEGA fabric 100 (that is, the second surface of the MEA fabric 110 to which the GDL fabric 120 is not bonded) which has passed through the gas injection device 50, and is configured to inspect the surface state of the MEGA fabric 100. The surface inspection device 60 inspects whether there is an abnormality on the surface of the MEGA fabric 100 by using the surface brightness or the like of the MEGA fabric 100. When the electrode 112 of the MEGA fabric wo is sensed, the surface inspection device 60 performs a surface inspection on a predetermined region of the MEGA fabric 100 including the electrode 112.

When a bonding defect between the MEA fabric 110 and the GDL fabric 120 occurs in the MEGA fabric 100, differences in surface brightness, color, reflected light, and the like occur between the first region in which the bonding defect occurs and the second region in which the bonding defect does not occur. Accordingly, the surface inspection device 60 may inspect whether the surface of the MEGA fabric 100 has an abnormality due to bonding defect through the differences in brightness, color, reflected light, and the like between the first region and the second region. For example, the surface inspection device 60 may inspect whether the surface state of the MEGA fabric 100 is abnormal using a vision camera, a surface roughness measuring device, an optical sensor, or the like.

The drying device 80 is configured to dry the liquid material injected from the steam injection device 40 and absorbed into the MEGA fabric 100. The drying device 80 is positioned downstream of the surface inspection device 60 to dry and remove the liquid material remaining in the MEGA fabric 100 on which the surface inspection has been completed. In this case, the drying device 80 may be positioned below the MEGA fabric 100 to face the second surface of the MEGA fabric 100. The drying device 80 may dry the MEGA fabric 100 by a drying method through a heating plate, hot air supply, or the like.

The MEGA winding unit 90 is configured to wind the MEGA fabric wo which has been dried through the drying device 80.

The system for manufacturing a MEGA of the present disclosure configured as described above may employ, as a fabric bonding device, the flat press 35 shown in FIG. 6 instead of the bonding roller 30 shown in FIG. 3. In the case of using the flat press 35, since the movement of the MEA fabric 110 is periodically stopped for bonding the MEA fabric 110 and the sheet-like GDL material (i.e., GDL sheet), the additional configurations (i.e., the linear driving devices) for horizontal movement of the gas injection unit 51 and the jig unit 52 may be omitted.

The flat press 35 heats, pressurizes and bonds the MEA fabric 110 and the GDL sheet 121 in a state where the movement of the MEA fabric 110 from the MEA unwinding unit 10 to the MEGA winding unit 90 is stopped. The MEA unwinding unit 10 stops the unwinding of the MEA fabric temporarily 110 when the electrode 112 of the MEA fabric 110 is positioned between an upper plate press and a lower plate press of the flat plate press 35. The flat press 35 may be supplied with the GDL sheet 121 of a predetermined size as a single sheet from a GDL tray 25.

A process of manufacturing the MEGA for a fuel cell using the above-described system for manufacturing a MEGA will be described below as an example.

First, the MEGA fabric 100 is manufactured by bonding the GDL material to the first surface of the MEA fabric 110. The MEA fabric 110 and the GDL material may be bonded through the bonding roller 30 or the flat press 35. The GDL material may use a fabric-type GDL material (i.e., the GDL fabric) or a sheet-type GDL material (i.e., the GDL sheet) according to a fabric bonding method. When the bonding roller 30 is used, the GDL fabric 120 is used, and when the flat press 35 is used, the GDL sheet 121 is used. Hereinafter, it is assumed that the GDL fabric 120 is used as the GDL material.

Next, the vaporized liquid material is injected downward and supplied to the first surface of the manufactured MEGA fabric 100 through the steam injection device 40. At this time, the electrolyte membrane fabric 111 of the MEA fabric 110 absorbs the liquid material and expands.

Then, the compressed gas is injected and supplied through the gas injection device 50 to the MEGA fabric 100 which has absorbed the liquid material. At this time, the gas injection device 50 injects compressed gas through the gas injection unit 51 in a state in which the second surface of the MEGA fabric wo (i.e., the surface of the GDL material) is brought into close contact with the upper surface of the gas injection unit 51 by the jig unit 52. The compressed gas is injected upward to the second surface of the MEGA fabric 100.

The GDL fabric 120 is made of carbon fiber and has a porous structure having gas permeability. Accordingly, the compressed gas injected from the gas injection unit 51 passes through the GDL fabric 120 and is supplied to the MEA fabric 110.

As shown in FIG. 7, if there is a first region A in which the MEA fabric 110 and the GDL fabric 120 are not joined to each other or the bonding force thereof is lower than the critical bonding force, when the MEA fabric 110 absorbs the liquid material, the MEA fabric 110 is separated and loosened from the GDL fabric 120 in the first region A (see A′). The reason is that the GDL fabric 120 allows the liquid material to pass through itself, and the MEA fabric 110 absorbs the liquid material and expands.

When the loosening phenomenon (see A′ in FIG. 7) occurs between the MEA fabric 110 and the GDL fabric 120, a minute gap is generated between the MEA fabric 110 and the GDL fabric 120. And, when the compressed gas is injected on the second surface of the MEGA fabric 100 in a state where the minute gap is generated between the MEA fabric 110 and the GDL fabric 120, the compressed gas that has passed through the GDL fabric 120 acts on the first surface of the MEA fabric 110 through the gap between the MEA fabric 110 and the GDL fabric 120. At this time, the gap between the GDL fabric 120 and the MEA fabric 110 is further widened by the compressed gas, and eventually, the phenomenon of the MEA fabric 110 being partially peeled off from the GDL fabric 120 (see A″ in FIG. 7) may occur.

When only compressed gas is injected to the MEGA fabric 100 without injecting the vaporized liquid material, since a gap in which the compressed gas acts is not secured between the MEA fabric 110 and the GDL fabric 120, the pressure of the compressed gas needs to be increased. When the pressure of the compressed gas is increased, the risk of damage to the MEA fabric 110 and the GDL fabric 120 also increases.

Therefore, in the present disclosure, by injecting a vaporized liquid material before the compressed air is injected on the MEGA fabric, the pressure of the compressed gas is reduced to minimize the risk of damage to the MEGA fabric.

After the compressed air is injected to the MEGA fabric 100, the surface of the MEGA fabric boo is inspected to determine whether it has abnormality using the surface inspection device 60. For example, by detecting a non-flat portion of the MEA fabric 110 using an optical sensor, a bonding defect of the MEGA fabric 100 and a surface abnormality resulting therefrom can be inspected.

When the MEA fabric 110 absorbs the liquid material and expands, wrinkles are formed in the first region A, which has a relatively insufficient bonding strength to the GDL fabric 120, and an uneven portion is generated in the first region A. In other words, when the MEA fabric 110 absorbs the liquid material and expands, wrinkles are formed in some regions where the bonding strength is insufficient, and thereby an uneven portion is generated in the surface which was flat. When the surface of the MEA fabric 110 is not flat, a difference in brightness of the surface occurs depending on the unevenness thereof. The first region A is a partial region of the MEA fabric 110 that is incompletely bonded to the GDL fabric 120 with a bonding force less than a critical value.

When the surface inspection device 60 detects a surface abnormality due to the bonding defect of the MEGA fabric 100, a marking may be formed in the region (i.e., bonding defect region) of the MEGA fabric 100 in which the surface abnormality is detected. For example, the marking may be formed on the bonding defect region of the MEGA fabric 100 by a marking device 70. Referring to FIG. 3, the marking device 70 may be positioned below the surface inspection device 60 and the MEGA fabric 100. When the surface abnormality of the MEGA fabric 100 is detected by the surface inspection device 60, the marking device 70 forms a marking on the bonding defect region of the MEGA fabric 100 positioned above the marking device 70.

The MEGA fabric 100 which has been inspected through the surface inspection device 60 is dried through the drying device 80, and then wound around the MEGA winding unit 90.

Then, the MEGA 100′ having a cross-sectional structure as shown in FIG. 2 is completed through a process of cutting the MEGA fabric 100 wound around the MEGA winding unit 90 to a predetermined size.

Referring to FIG. 2, the MEGA 100′ includes an MEA 110′ and a GDL 120′ bonded to one surface of the MEA 110′, and the MEA 110′ includes an electrolyte membrane 111′ and a pair of electrodes 112 bonded to both surfaces of the electrolyte membrane 111′.

While the embodiments of the present disclosure have been described in detail above, the terms or words used in the present specification and claims should not be construed as being limited to conventional or dictionary meanings, and the scope of the patent right of the present disclosure is not limited thereto, but various modifications and improvements which could be made by those skilled in the art using the basic concept of the present disclosure defined in the following claims would also fall within the scope of the patent right of the present disclosure.

What is claimed is:

1. A method comprising:
manufacturing a membrane-electrode-gas diffusion layer assembly (MEGA) fabric by bonding a gas diffusion layer (GDL) material to a first surface of a membrane-electrode assembly (MEA) fabric;
injecting, by a steam injector, a liquid material to a first surface of the MEGA fabric while allowing the liquid material to be absorbed to the first surface of the MEGA fabric;
supplying, by a gas injector, compressed gas to a second surface of the MEGA fabric 111 which the liquid material has been absorbed;
inspecting, by a surface inspection device, a surface state of the MEGA fabric after supplying the compressed gas; and
after the inspecting, winding the MEGA fabric around a MEGA winding unit.

2. The method of claim 1, wherein the first surface of the MEGA fabric is a second surface of the MEA fabric to which the GDL material is not bonded.

3. The method of claim 1, wherein the second surface of the MEGA fabric is a surface of the GDL material bonded to the first surface of the MEA fabric.

4. The method of claim 1, wherein the GDL material has a porous structure.

5. The method of claim 1, wherein the MEA fabric includes an electrolyte membrane fabric that expands when absorbing the liquid material, and a plurality of electrodes provided on both surfaces of the electrolyte membrane fabric.

6. The method of claim 1, wherein the gas injector comprises:
a gas injection unit positioned below the second surface of the MEGA fabric, the gas injection unit being able to supply the compressed gas toward the second surface of the MEGA fabric; and
a jig unit positioned above the first surface of the MEGA fabric, the jig unit being able to move down, and to bring the second surface of the MEGA fabric into close contact with the gas injection unit.

7. The method of claim 6, wherein the gas injection unit is configured to inject the compressed gas when the second surface of the MEGA fabric is brought into close contact with the gas injection unit by the jig unit.

8. The method of claim 6, wherein the jig unit has a frame structure having an inner diameter greater than an outer diameter of an electrode provided on the MEA fabric.

9. The method of claim 8, wherein when the jig unit is moved toward the first surface of the MEGA fabric, the jig unit is moved so that the electrode of the MEA fabric is positioned in an inner space of the jig unit.

10. The method of claim 1, further comprising forming a marking on a region of the MEGA fabric where a surface abnormality is detected when the surface inspection device detects the surface abnormality.

11. A system comprising:
a fabric bonding device configured to manufacture a membrane-electrode-gas diffusion layer assembly (MEGA) fabric by bonding a gas diffusion layer (GDL) material to a first surface of a membrane-electrode assembly (MEA) fabric;
a steam injector configured to inject a liquid material on a first surface of the MEGA fabric;
a gas injector configured to supply a compressed gas to a second surface of the MEGA fabric in which the liquid material has been absorbed;
a surface inspection device configured to inspect a surface state of the MEGA fabric to which the compressed gas has been supplied; and
a MEGA winding unit configured to wind the MEGA fabric which has been inspected by the surface inspection device.

12. The system of claim 11, wherein the first surface of the MEGA fabric is a second surface of the MEA fabric to which the GDL material is not bonded.

13. The system of claim 11, wherein the second surface of the MEGA fabric is a surface of the GDL material bonded to the first surface of the MEA fabric.

14. The system of claim 11, wherein the GDL material has a porous structure.

15. The system of claim 11, wherein the MEA fabric includes an electrolyte membrane fabric that expands when the liquid material is absorbed, and a plurality of electrodes provided on both surfaces of the electrolyte membrane fabric.

16. The system of claim 11, wherein the gas injector includes:
a gas injection unit positioned below the second surface of the MEGA fabric, the gas injection unit configured to supply the compressed gas toward the second surface of the MEGA fabric; and
a jig unit positioned above the first surface of the MEGA fabric, the jig unit configured to move down and to bring the second surface of the MEGA fabric into close contact with the gas injection unit.

17. The system of claim 16, wherein the gas injection unit is configured to inject the compressed gas when the second surface of the MEGA fabric is brought into close contact with the gas injection unit by the jig unit.

18. The system of claim 16, wherein the jig unit has a frame structure having an inner diameter greater than an outer diameter of an electrode on the MEA fabric.

19. The system of claim 18, wherein the electrode of the MEA fabric is positioned in an inner space of the jig unit when the jig unit is moved toward the first surface of the MEGA fabric.

20. The system of claim 11, further comprising a marking device configured to form a marking on a region of the MEGA fabric where a surface abnormality is detected when the surface inspection device detects the surface abnormality.
